(19) United States
(12) Patent Application Publication
(10) Pub. No.: US 2026/0206116 A1
(43) Pub. Date: Jul. 16, 2026

(54) HIGHLY COMPATIBLE LIGHTING DEVICE DRIVER

(71) Applicant: Xiamen PVTECH Co., Ltd., Xiamen (CN)

(72) Inventors: Rongtu LIU, Xiamen (CN); Fuxing LU, Xiamen (CN); Chunming LIU, Xiamen (CN)

(21) Appl. No.: 19/567,148

(22) Filed: Mar. 15, 2026

Related U.S. Application Data
(63) Continuation-in-part of application No. 19/012,883, filed on Jan. 8, 2025.

(30) Foreign Application Priority Data
Dec. 11, 2025 (CN) 202511869970.X

(51) Int. Cl. H05B 47/17; H05B 45/325; H05B 45/3725

(52) U.S. Cl. CPC H05B 47/17; H05B 45/325; H05B 45/3725

(57) ABSTRACT

A highly compatible lighting device driver includes an input module, a rectification module, a driving control module, a power conversion module and an inductive module. The input module couples an input signal. The rectification module is connected to the input module, and rectifies the input signal to generate a rectified signal. The driving control module is connected to the rectification module, and includes a control unit and a signal identification unit connected to each other. The power conversion module is connected to the driving control module, the control unit, and a load. The inductive ballast mode control module is connected to the input module, the rectification module, and the load.

### TECHNICAL FIELD

The disclosure relates to a lighting device driver, in particular to a highly compatible lighting device driver.

### BACKGROUND

With advancements in technology, the functionality and efficiency of light tubes have significantly improved. To achieve compatibility with both utility power and electronic ballast, multifunctional light tubes have been developed and are now widely used in the market.

Although currently available light tubes compatible with both utility power and electronic ballast offer great convenience, their circuit structures are complex, leading to significantly higher costs. For the same reason, the complex circuit structures of these light tubes require additional circuit modules and more electronic components. Consequently, these light tubes demand larger internal space, so the size of these light tube cannot be reduced.

In addition, there is currently a lack of light tubes capable of simultaneously being compatible with utility power, electronic ballast, and inductive ballast, and thus they cannot meet the requirements of different applications.

### SUMMARY

One embodiment of the disclosure provides a highly compatible lighting device driver, which includes an input module, a rectification module, a driving control module, a power conversion module and an inductive ballast mode control module. The input module couples an input signal. The rectification module is connected to the input module, and rectifies the input signal to generate a rectified signal. The driving control module is connected to the rectification module, and includes a control unit and a signal identification unit connected to each other. The power conversion module is connected to the driving control module, the control unit, and a load. The inductive ballast mode control module is connected to the input module, the rectification module, and the load.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is the block diagram of the highly compatible lighting device driver in accordance with the first embodiment of the disclosure.

FIG. 2 is the circuit diagram of the highly compatible lighting device driver in accordance with the second embodiment of the disclosure.

FIG. 3 is the schematic view of the highly compatible lighting device driver operating in the utility power mode in accordance with the second embodiment of the disclosure.

FIG. 4 is the schematic view of the pulse-width modulation signal of the highly compatible lighting device driver in accordance with the second embodiment of the disclosure.

FIG. 5 is the schematic view of the highly compatible lighting device driver operating in the ballast mode in accordance with the second embodiment of the disclosure.

FIG. 6 is the schematic view of the direct-current signal of the highly compatible lighting device driver in accordance with the second embodiment of the disclosure.

FIG. 7 is the block diagram of the highly compatible lighting device driver in accordance with the third embodiment of the disclosure.

FIG. 8 is the circuit diagram of the inductive ballast.

FIG. 9 is the circuit diagram of the inductive ballast mode control module of the highly compatible lighting device driver in accordance with the third embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

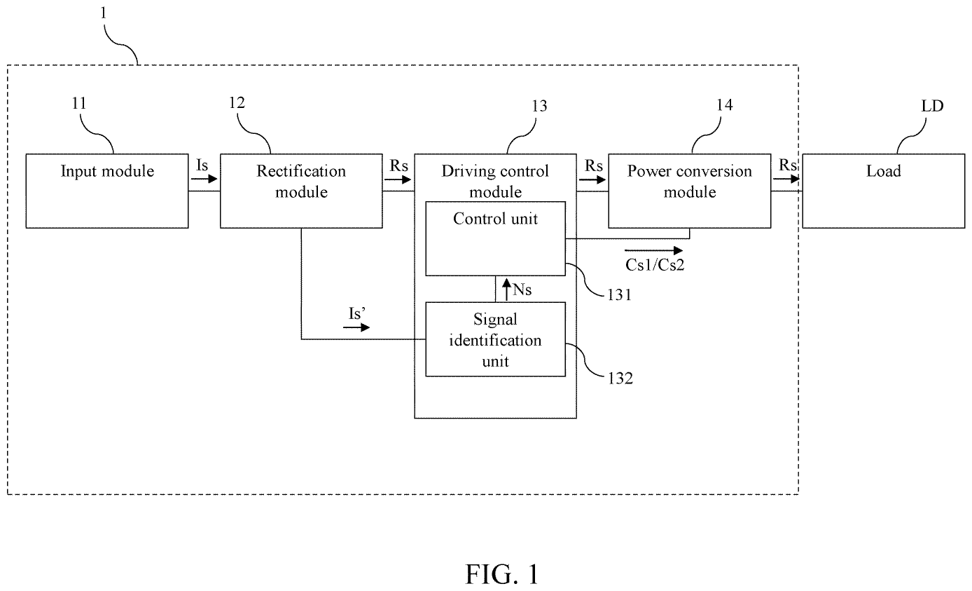

Please refer to FIG. 1, which is the block diagram of the highly compatible lighting device driver in accordance with the first embodiment of the disclosure. As shown in FIG. 1, the lighting device driver 1 includes an input module 11, a rectification module 12, a driving control module 13, and a power conversion module 14.

The input module 11 is connected to an external power source to couple an input signal Is, which is outputted by the power source. The power source can be a utility power or an electronic ballast GH.

The rectification module 12 is connected to the input module 11 and rectifies the input signal Is to generate a rectified signal Rs.

The driving control module 13 is connected to the rectification module 12, and includes a control unit 131 and a signal identification unit 132 connected to each other. The control unit 131 is connected to the rectification module 12, and the signal identification unit 132 is also connected to the rectification module 12, allowing a portion of the input signal Is'to be coupled to the signal identification unit 132. Thus, the signal identification unit 132 can generate an identification signal Ns. In one embodiment, the control unit 131 can be a microcontroller (MCU). In another embodiment, the control unit 131 can be a central processing unit (CPU), an application-specific integrated circuit (ASIC), a field-programmable gate array (FPGA), or other similar components. The signal identification unit 132 can be a component with energy storage functionality. In one embodiment, the signal identification unit 132 is a capacitor Cp. The signal identification unit 132 can be connected to the input module 11 via another capacitor Cp (the capacitor Cp can be disposed within the rectification module 12, to couple a portion of the input signal Is'to the signal identification unit 132. Alternatively, the signal identification unit 132 can be directly connected to the input module 11. In another embodiment, the signal identification unit 132 can be an inductor L1 or a circuit structure including multiple electronic components (such as capacitors Cp, inductors L1, and resistors). Additionally, the driving control module 13 can include an impedance identification and detection unit 133. The impedance identification and detection unit 133 is connected to the rectified signal output terminal VB+of the rectification module 12 and the control unit 131. The impedance identification and detection unit 133 detects the impedance of the rectified signal Rs. The control unit 131 enters a protection state when the impedance exceeds the preset impedance threshold, thereby achieving an impedance detection mechanism. This mechanism effectively detects whether a human body resistance is connected to the lighting device driver 1, preventing electric shocks. Consequently, the safety performance of the lighting device driver 1 is significantly enhanced.

The power conversion module 14 is connected to the driving control module 13, the control unit 131, and the load LD. In one embodiment, the load LD can include one or more light sources LS, such as light-emitting diodes (LEDs). In another embodiment, the light source LS can also be a bulb, a tube light, or other similar components. The rectified signal Rs drives the load LD via the driving control module 13 and the power conversion module 14.

The control unit 131 controls the power conversion module 14 to switch the operating mode based on the frequency of the identification signal Ns. The control unit 131 enters the ballast mode when the frequency of the identification signal Ns is greater than or equal to the preset frequency threshold. In the ballast mode, the control unit 131 generates a direct-current signal Cs1 to control the power conversion module 14 to keep the switch of the power conversion module 14 fully conductive. Conversely, the control unit 131 enters the utility power mode when the frequency of the identification signal Ns is lower than the preset frequency threshold. In the utility power mode, the control unit 131 generates a pulse-width modulation signal Cs2 to control the power conversion module 14 for power conversion.

The above circuit structure implements a control mechanism based on input signal identification. Via this mechanism, the lighting device driver 1 can selectively output either the direct-current signal Cs1 or the pulse-width modulation signal Cs2 to switch between the utility power mode and the ballast mode. Therefore, the lighting device driver 1 achieves high compatibility, so the lighting device driver 1 can be more comprehensive in application.

In this embodiment, the lighting device driver 1 achieves high compatibility through the control mechanism based on input signal identification without requiring additional circuit modules. Furthermore, the circuit structure of the lighting device driver 1 can simultaneously support the utility power mode and the ballast mode. As a result, the circuit structure of the lighting device driver 1 can be significantly simplified, substantially reducing the cost thereof. Thus, the lighting device driver 1 can meet actual requirements.

Additionally, in this embodiment, the lighting device driver 1 achieves high compatibility through the control mechanism based on input signal identification without requiring additional circuit modules. As a result, the circuit structure of the lighting device driver 1 can be significantly simplified, reducing the number of electronic components required. Consequently, the size of the lighting device driver 1 can be reduced to achieve miniaturization, aligning with future development trends.

The embodiment just exemplifies the disclosure and is not intended to limit the scope of the disclosure; any equivalent modification and variation according to the spirit of the disclosure is to be also included within the scope of the following claims and their equivalents.

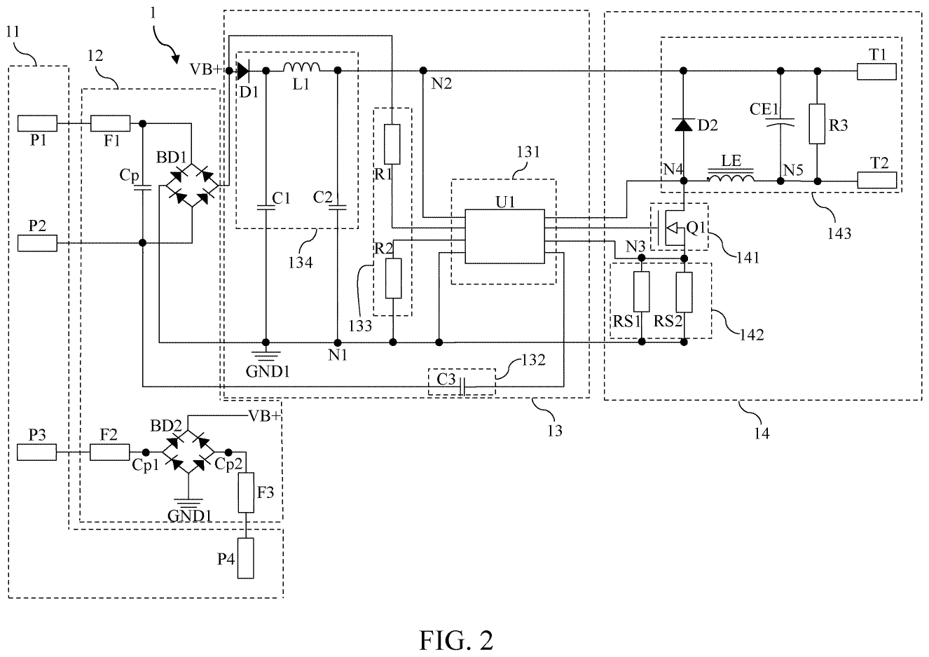

Please refer to FIG. 2, which is the circuit diagram of the highly compatible lighting device driver in accordance with the second embodiment of the disclosure. Please also refer to FIG. 1. FIG. 2 illustrates the circuit structure of the lighting device driver 1. This embodiment is for illustration purposes only; the circuit structures of the input module 11, rectification module 12, driving control module 13, and power conversion module 14 may vary according to actual needs. As shown in FIG. 2, the lighting device driver 1 includes an input module 11, a rectification module 12, a driving control module 13, and a power conversion module 14.

The input module 11 includes a first input terminal P1, a second input terminal P2, a third input terminal P3, and a fourth input terminal P4.

The rectification module 12 is connected to the input module 11. The rectification module 12 includes a first rectifier BD1, a second rectifier BD2, a first fuse F1, a second fuse F2, a third fuse F3, and a capacitor Cp. The first end of the first rectifier BD1 is connected to the second input terminal P2. The second end of the first rectifier BD1 is connected to the rectified signal output terminal VB+. The third end of the first rectifier BD1 is connected to the first input terminal P1 via the first fuse F1. The fourth end of the first rectifier BD1 is connected to the first node N1. The first node N1 is connected to the first ground GND1. The first end of the second rectifier BD2 is connected to the fourth input terminal P4 through the third fuse F3. The second end of the second rectifier BD2 is connected to the rectified signal output terminal VB+. The third end of the second rectifier BD2 is connected to the third input terminal P3 via the second fuse F2. The fourth end of the second rectifier BD2 is connected to the first ground GND1. In one embodiment, the first rectifier BD1 and the second rectifier BD2 can be bridge rectifiers (full-wave rectifiers or half-wave rectifiers). In another embodiment, the first rectifier BD1 and the second rectifier BD2 can be bipolar junction transistors, circuits including transistors, or any existing circuits or electronic components with rectification functions.

The driving control module 13 is connected to the rectification module 12. The driving control module 13 includes a control unit 131, a signal identification unit 132, an impedance identification and detection unit 133, and a direct-current signal smoothing unit 134 connected to each other. The control unit 131 may have at least one signal identification interface, which is connected to the signal identification unit 132 via this interface. The direct-current signal smoothing unit 134 includes a first diode D1, an inductor L1, a first capacitor C1, and a second capacitor C2. The anode of the first diode D1 is connected to the rectified signal output terminal VB+, and the cathode is connected to one end of the inductor L1. The other end of the inductor L1 is connected to the second node N2 and to the first ground GND1 via the second capacitor C2. The impedance identification and detection unit 133 includes a plurality of resistors connected in series. In this embodiment, the impedance identification and detection unit 133 includes a first resistor R1 and a second resistor R2. The two ends of the first resistor R1 are connected to the rectified signal output terminal VB+and the control unit 131, respectively. The two ends of the second resistor R2 are connected to the control unit 131 and the first node N1, respectively. The signal identification unit 132 includes a third capacitor C3, which is connected to the first input terminal P1 through the capacitor Cp, allowing a portion of the input signal Is′ to be coupled to the third capacitor C3 (signal identification unit 132). The control unit 131 includes a controller U1, which can be but is not limited to a microcontroller.

The power conversion module 14 is connected to the control unit 131. The power conversion module 14 includes a switch unit 141, an output unit 143, and a sampling unit 142. The sampling unit 142 includes a first sampling resistor RS1 and a second sampling resistor RS2 connected in parallel. One end of the first sampling resistor RS1 is connected to the first node N1, and the other end thereof is connected to the third node N3. The switch unit 141 includes a first switch Q1, which may be a metal-oxide-semiconductor field-effect transistor. In another embodiment, the first switch Q1 may also be a bipolar junction transistor or other similar components. The first end (gate) of the first switch Q1 is connected to the control unit 131, the second end (source) thereof is connected to the third node N3, and the third end (drain) thereof is connected to the fourth node N4. The third node N3 and the fourth node N4 are both connected to the control unit 131. The output unit 143 includes a second diode D2, an energy storage inductor LE, a first electrolytic capacitor CE1, a third resistor R3, a first output terminal T1, and a second output terminal T2. The anode and cathode of the second diode D2 are connected to the fourth node N4 and the second node N2, respectively. The two ends of the energy storage inductor LE are connected to the fourth node N4 and the fifth node N5, respectively. The two ends of the first electrolytic capacitor CE1 are connected to the fifth node N5 and the second node N2, respectively. The two ends of the third resistor R3 are connected to the fifth node N5 and the second node N2, respectively. The second node N2 and the fifth node N5 are connected to the first output terminal T1 and the second output terminal T2, respectively.

The embodiment just exemplifies the disclosure and is not intended to limit the scope of the disclosure; any equivalent modification and variation according to the spirit of the disclosure is to be also included within the scope of the following claims and their equivalents.

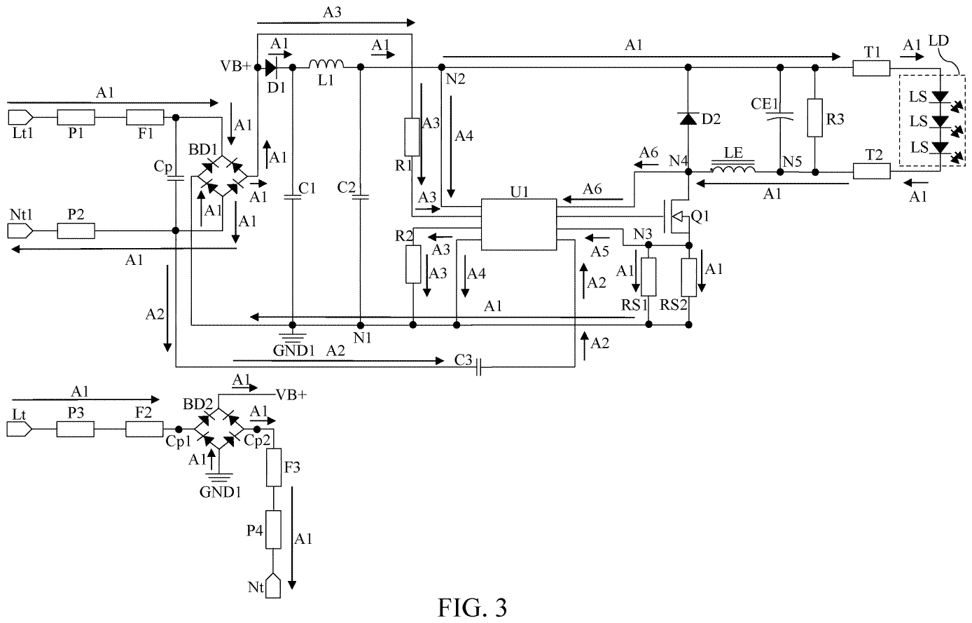

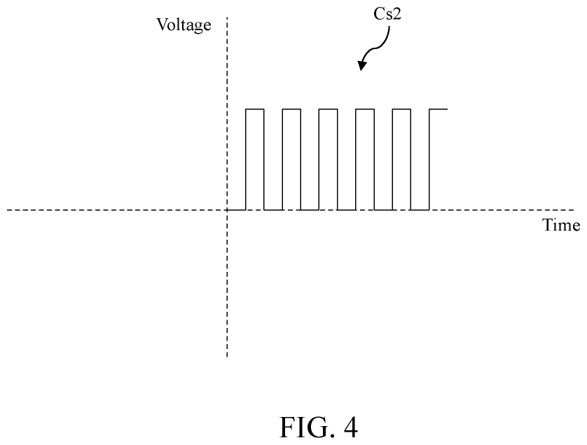

Please refer to FIG. 3 and FIG. 4. Please also refer to FIG. 1 and FIG. 2. FIG. 3 is the schematic view of the highly compatible lighting device driver operating in the utility power mode in accordance with the second embodiment of the disclosure. FIG. 4 is the schematic view of the pulse-width modulation signal of the highly compatible lighting device driver in accordance with the second embodiment of the disclosure. As shown FIG. 3 and FIG. 4, the load LD includes a plurality of light sources LS, which can be light-emitting diodes. The load LD is connected to the first output terminal T1 and the second output terminal T2 of the output unit 143. When the input module 11 is connected to the utility power (Lt1, Nt1, Lt, and Nt represent the output terminals of the utility power), the input module 11 couples the input signal Is, and the rectification module 12 rectifies the input signal Is to generate the rectified signal Rs. Then, a portion of the input signal Is'is coupled to the signal identification unit 132 via the capacitor Cp of the rectification module 12, allowing the signal identification unit 132 to generate the identification signal Ns, as indicated by the arrow A2. When the frequency of the identification signal Ns is lower than the preset frequency threshold (which may be but is not limited to 22 kHz and can be adjusted based on actual needs), the control unit 131 enters the utility power mode. In this mode, the control unit 131 generates a pulse-width modulation signal Cs2 (as shown in FIG. 4) to control the power conversion module 14 for power conversion. In this case, the switch unit 141 is continuously turned on and off, enabling the power conversion module 14 to perform power conversion. The impedance identification and detection unit 133 of the driving control module 13 detects the impedance of the rectified signal Rs, as indicated by the arrow A3. If the impedance exceeds the preset impedance threshold (which may be but is not limited to 400 ohms and can be adjusted based on actual needs), the control unit 131 enters the protection state. This condition indicates that a human body resistance may be connected to the lighting device driver 1, causing the control unit 131 to stop sending signals to the switch unit 141 of the power conversion module 14. The direct-current signal smoothing unit 134 converts the rectified signal Rs into a smoothed direct-current signal Cs1 to power the driving control module 13, as indicated by the arrow A4. The sampling unit 142 of the power conversion module 14 generates a feedback signal based on the peak current when the switch unit 141 is turned on, and the control unit 131 adjusts the pulse-width modulation signal Cs2 based on the feedback signal, as indicated by the arrow A5. The control unit 131 can also receive a zero-crossing detection signal from the fourth node N4 to perform zero-crossing detection, as indicated by the arrow A6. The rectified signal Rs drives the load LD via the power conversion module 14 (the switch unit 141, the output unit 143, and the sampling unit 142). The path of the rectified signal Rs is shown as the arrow A1.

The embodiment just exemplifies the disclosure and is not intended to limit the scope of the disclosure; any equivalent modification and variation according to the spirit of the disclosure is to be also included within the scope of the following claims and their equivalents.

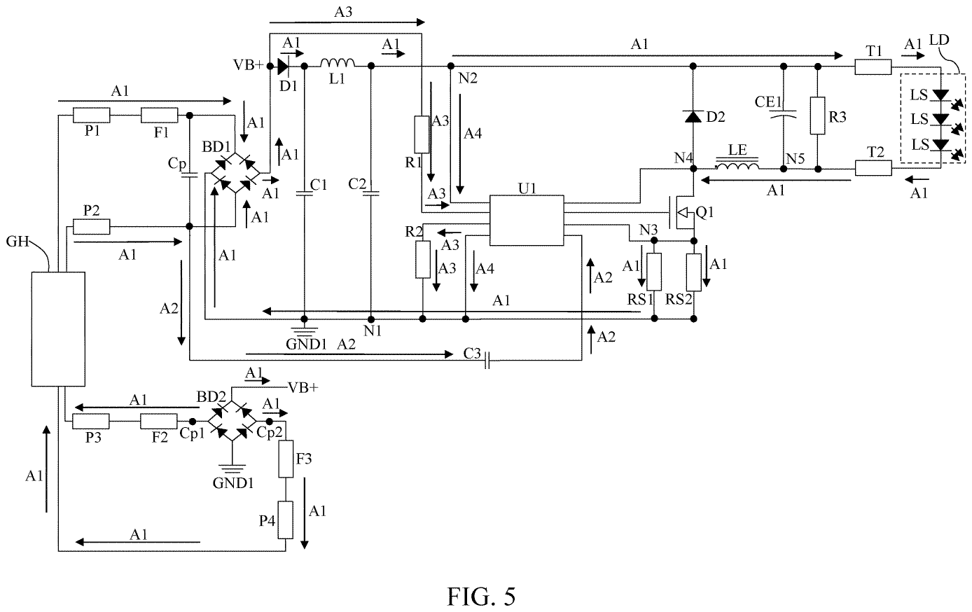

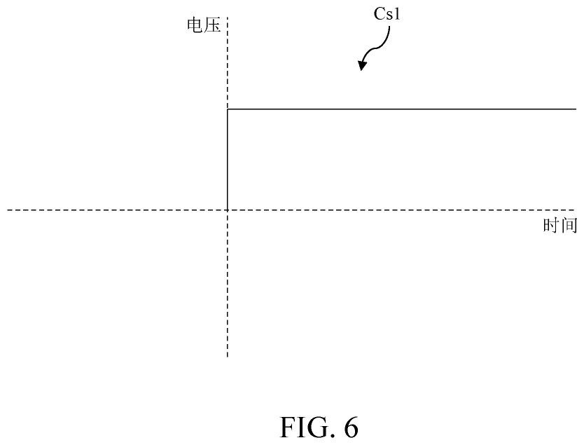

Please refer to FIG. 5 and FIG. 6. Please also refer to FIG. 1 and FIG. 2. FIG. 5 is the schematic view of the highly compatible lighting device driver operating in the ballast mode in accordance with the second embodiment of the disclosure. FIG. 6 is the schematic view of the direct-current signal of the highly compatible lighting device driver in accordance with the second embodiment of the disclosure.

As shown in FIG. 5 and FIG. 6, the load LD includes a plurality of light sources LS, which may be light-emitting diodes. The load LD is connected to the first output terminal T1 and the second output terminal T2 of the output unit 143. When the input module 11 is connected to the electronic ballast GH, the input module 11 generates an input signal Is. The rectification module 12 rectifies the input signal Is to produce a rectified signal Rs. Subsequently, a portion of the input signal Is', through the capacitor Cp of the rectification module 12, is coupled to the signal identification unit 132, enabling the signal identification unit 132 to generate an identification signal Ns, as indicated by the arrow A2.

When the frequency of the identification signal Ns exceeds the preset frequency threshold (which can be, but is not limited to, 22 kHz and may be adjusted as needed), the control unit 131 enters the ballast mode. In this mode, the control unit 131 generates the direct-current signal Cs1 (as shown in FIG. 6) to control the continuous conduction of the switch of the power conversion module 14. Under these circumstances, the switch unit 141 can maintain a continuously conductive state to form a closed loop. In this way, the rectified signal Rs, generated after rectifying the signal input from the electronic ballast GH, can directly drive the load LD. The impedance identification and detection unit 133 of the driving control module 13 detects the impedance of the rectified signal Rs, as indicated by the arrow A3. When the impedance exceeds the preset impedance threshold (which can be, but is not limited to, 400 ohms and may be adjusted as needed), the control unit 131 enters a protection state. This condition indicates the possible connection of a human resistance to the lighting device driver 1, prompting the control unit 131 to shut down or cease sending signals to the switch unit 141 of the power conversion module 14. The direct-current signal smoothing unit 134 converts the rectified signal Rs into a smoothed direct-current signal Cs1 to supply power to the driving control module 13, as indicated by the arrow A4. After being further smoothed via the power conversion module 14 (including the switch unit 141, the output unit 143, and the sampling unit 142), the rectified signal Rs drives the load LD. The path of the rectified signal Rs is illustrated by arrow A1 in the figure.

As previously stated, via the input signal identification-based control mechanism, the lighting device driver 1 can selectively output the direct-current signal Cs1 or the pulse-width modulation signal Cs2 to switch between the utility power mode and the ballast mode. Therefore, the lighting device driver 1 achieves high compatibility, so the lighting device driver 1 can be more comprehensive in application.

Additionally, in this embodiment, the lighting device driver 1 achieves high compatibility through the aforementioned input signal identification-based control mechanism without requiring additional circuit modules. Furthermore, the circuit structure of the lighting device driver 1 can simultaneously realize both the utility power mode and the ballast mode. As a result, the circuit structure of the lighting device driver 1 can be greatly simplified, significantly reducing the cost of the lighting device driver 1. Thus, the lighting device driver 1 meets actual requirements.

Moreover, in this embodiment, the lighting device driver 1 achieves high compatibility through the above control mechanism based on input signal identification without requiring additional circuit modules. This simplification in the circuit structure reduces the number of electronic components needed for the lighting device driver 1, thereby minimizing its size. This enables the lighting device driver 1 to meet the trend toward miniaturization in future developments.

Additionally, in this embodiment, the driving control module 13 of the lighting device driver 1 also includes the impedance identification and detection unit 133. The impedance identification and detection unit 133 is connected to the rectified signal output terminal VB+of the rectification module 12 and the control unit 131. The impedance identification and detection unit 133 detects the impedance of the rectified signal Rs. When the impedance exceeds the preset impedance threshold, the control unit 131 enters a protection state. This impedance detection mechanism effectively detects whether human resistance is connected to the lighting device driver 1, thereby preventing electric shock incidents. As a result, the safety performance of the lighting device driver 1 is significantly enhanced.

The embodiment just exemplifies the disclosure and is not intended to limit the scope of the disclosure; any equivalent modification and variation according to the spirit of the disclosure is to be also included within the scope of the following claims and their equivalents.

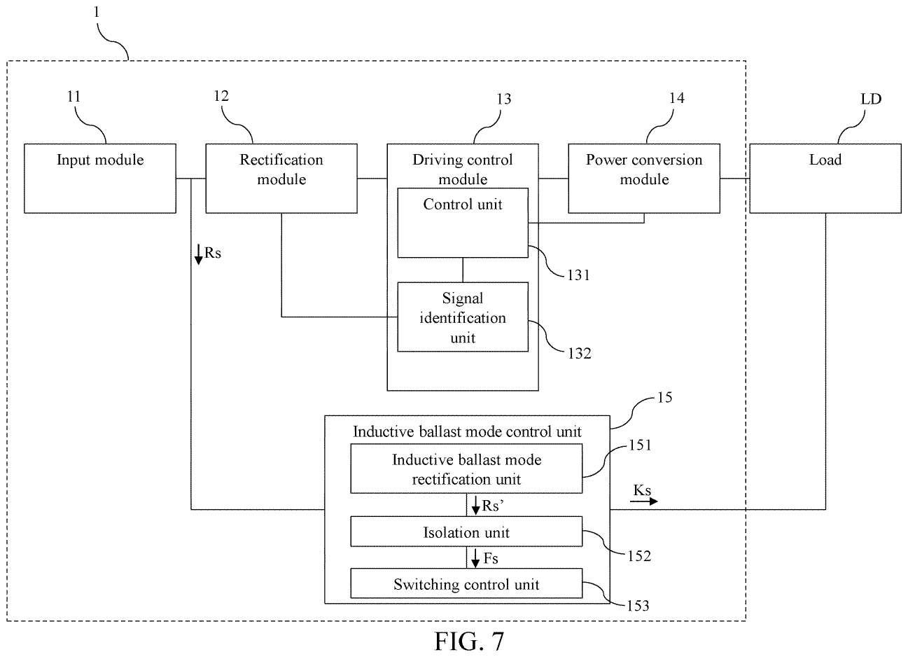

Please refer to FIG. 7, which is the block diagram of the highly compatible lighting device driver in accordance with the third embodiment of the disclosure. As shown in FIG. 7, the lighting device driver 1 includes an input module 11, a rectification module 12, a driving control module 13, and a power conversion module 14.

The above elements are similar to those of the previous embodiments and will not be repeated here. The difference between this embodiment and the previous embodiments is that the lighting device driver 1 further includes an inductive ballast mode control module 15. The inductive ballast mode control module 15 is connected to the input module 11, the rectification module 12, and the load LD.

The inductive ballast mode control module 15 includes an inductive ballast mode rectification unit 151, an isolation unit 152, and a switching control unit 153. The inductive ballast mode rectification unit 151 is connected to the input module 11 and the rectification module 12. The isolation unit 152 is connected to the inductive ballast mode rectification unit 151. The switching control unit 153 is connected to the isolation unit 152 and the load LD.

When the input module 11 is connected to the inductive ballast LH, the inductive ballast mode control module 15 enters the inductive ballast mode. In the inductive ballast mode, the rectified signal Rs passes through the inductive ballast mode rectification unit 151 to generate a rectified output signal Rs'. Thereafter, the rectified output signal Rs'passes through the isolation unit 152 to generate an isolation control signal Fs. The isolation control signal Fs passes through the switching control unit 153 to generate a switching control signal Ks so as to control the load LD.

Through the above circuit design, the lighting device driver 1 can selectively output either the direct-current signal Cs1 or the pulse-width modulation signal Cs2 to switch between the utility power mode and the ballast mode, thereby being compatible with the utility power and the electronic ballast GH. In addition, the lighting device driver 1 can also enter the inductive ballast mode when connected to the inductive ballast LH, allowing compatibility with the inductive ballast LH. Therefore, the lighting device driver 1 can be simultaneously compatible with the utility power, the electronic ballast GH, and the inductive ballast LH in order to meet the requirements of different applications.

The embodiment just exemplifies the disclosure and is not intended to limit the scope of the disclosure; any equivalent modification and variation according to the spirit of the disclosure is to be also included within the scope of the following claims and their equivalents.

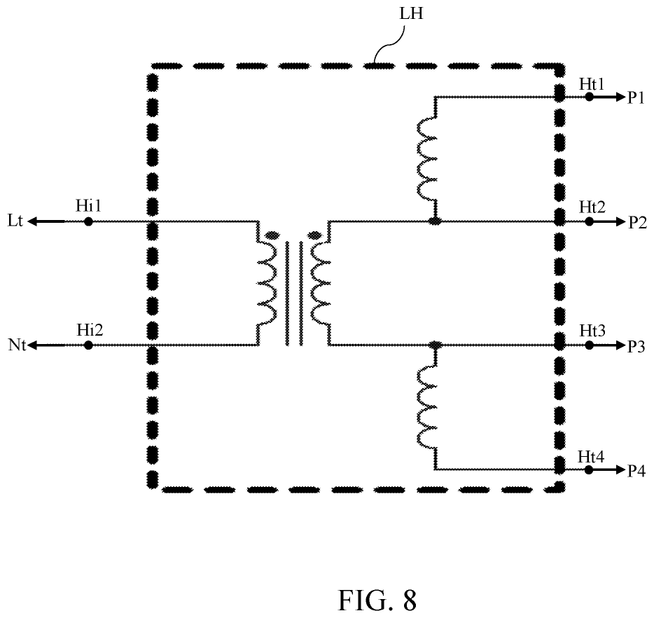

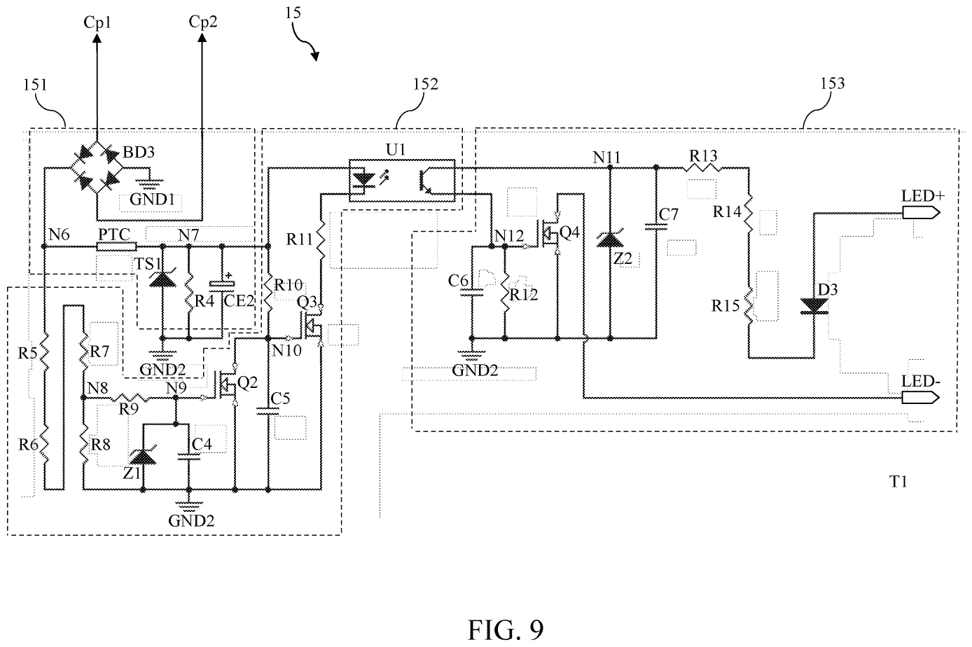

Please refer to FIG. 8 and FIG. 9. FIG. 8 is the circuit diagram of the inductive ballast. FIG. 9 is the circuit diagram of the inductive ballast mode control module of the highly compatible lighting device driver in accordance with the third embodiment of the disclosure. FIG. 8 illustrates the circuit structure of a currently available inductive ballast. As shown in FIG. 8, the inductive ballast LH has two input terminals Hi1 and Hi2, which are respectively connected to the live wire output terminal and neutral wire output terminal of the utility power. The inductive ballast LH further has four output terminals Ht1, Ht2, Ht3, and Ht4, which are respectively connected to a first input terminal P1, a second input terminal P2, a third input terminal P3, and a fourth input terminal P4 of the input module 11.

As shown in FIG. 9, the inductive ballast mode rectification unit 151 includes a third rectifier BD3, a thermistor PTC, a transient voltage suppression diode TS1, a fourth resistor R4, and a second electrolytic capacitor CE2.

The first end of the third rectifier BD3 is connected to a second ground GND2. The second end of the third rectifier BD3 is connected to the third end (the first connection point Cp1 shown in FIG. 2, FIG. 3 and FIG. 5) of the second rectifier BD2. The third end of the third rectifier BD3 is connected to the sixth node N6. The fourth end of the third rectifier BD3 is connected to a first end (the second connection point Cp2 shown in FIG. 2, FIG. 3 and FIG. 5) of the second rectifier BD2. In one embodiment, the third rectifier BD3 may be a bridge rectifier (full-wave or half-wave rectifier). In another embodiment, the third rectifier BD3 may be a bipolar junction transistor, circuit including transistors, or any existing circuits or electronic components with rectification functions. One end of the thermistor PTC is connected to the sixth node N6, and the other end is connected to the seventh node N7. The cathode of the transient voltage suppression diode TS1 is connected to the seventh node N7, and the anode thereof is connected to the second ground GND2. One end of the fourth resistor R4 is connected to the seventh node N7, and the other end thereof is connected to the second ground GND2. One end of the second electrolytic capacitor CE2 is connected to the seventh node N7, and the other end thereof is connected to the second ground GND2.

The isolation unit 152 includes a fifth resistor R5, a sixth resistor R6, a seventh resistor R7, an eighth resistor R8, a ninth resistor R9, a tenth resistor R10, an eleventh resistor R11, a first Zener diode Z1, a fourth capacitor C4, a fifth capacitor C5, a second switch Q2, a third switch Q3, and a photo coupler U1.

The fifth resistor R5, the sixth resistor R6, and the seventh resistor R7 form a serial circuit. One end of the serial circuit is connected to the sixth node N6, and the other end thereof is connected to the eighth node N8. One end of the eighth resistor R8 is connected to the eighth node N8, and the other end thereof is connected to the second ground GND2. One end of the ninth resistor R9 is connected to the eighth node N8, and the other end thereof is connected to the ninth node N9. The cathode of the first Zener diode Z1 is connected to the ninth node N9, and the anode thereof is connected to the second ground GND2. One end of the fourth capacitor C4 is connected to the ninth node N9, and the other end thereof is connected to the second ground GND2. The first end (gate) of the second switch Q2 is connected to the ninth node N9, the second end (source) thereof is connected to the second ground GND2, and the third end (drain) thereof is connected to the tenth node N10. One end of the fifth capacitor C5 is connected to the tenth node N10, and the other end thereof is connected to the second ground GND2. One end of the tenth resistor R10 is connected to the seventh node N7, and the other end thereof is connected to the tenth node N10. The first end (gate) of the third switch Q3 is connected to the tenth node N10, the second end (source) thereof is connected to the second ground GND2, and the third end (drain) is connected to one end of the eleventh resistor R11. The other end of the eleventh resistor R11 is connected to one input terminal of the photo coupler U1. The other input terminal of the photo coupler U1 is connected to the seventh node N7. One output terminal of the photo coupler U1 is connected to the eleventh node N11, and the other output terminal thereof is connected to the twelfth node N12.

The switching control unit 153 includes a sixth capacitor C6, a seventh capacitor C7, a twelfth resistor R12, a thirteenth resistor R13, a fourteenth resistor R14, a fifteenth resistor R15, a fourth switch Q4, a second Zener diode Z2, a third diode D3, a positive output terminal LED+, and a negative output terminal LED−.

One end of the sixth capacitor C6 is connected to the twelfth node N12, and the other end thereof is connected to the second ground GND2. One end of the twelfth resistor R12 is connected to the twelfth node N12, and the other end thereof is connected to the second ground GND2. The first end (gate) of the fourth switch Q4 is connected to the twelfth node N12, the second end (source) thereof is connected to the second ground GND2, and the third end (drain) thereof is connected to the negative output terminal LED−. The cathode of the second Zener diode Z2 is connected to the eleventh node N11, and the anode thereof is connected to the second ground GND2. One end of the seventh capacitor C7 is connected to the eleventh node N11, and the other end thereof is connected to the second ground GND2. The thirteenth resistor R13, fourteenth resistor R14, and fifteenth resistor R15 form a serial circuit, one end of the serial circuit is connected to the eleventh node N11, and the other end thereof is connected to the cathode of the third diode D3. The anode of the third diode D3 is connected to the positive output terminal LED+. The positive output terminal LED+ and the negative output terminal LED− are connected to the load LD. In another embodiment, the third end (drain) of the fourth switch Q4 may be connected to a second output terminal T2 of the output unit 143, while the anode of the third diode D3 may be connected to the first output terminal T1 of the output unit 143 to connect to the load LD.

When the input module 11 of the inductive ballast mode control module 15 is connected to the inductive ballast LH and the inductive ballast LH is connected to the utility power, the inductive ballast mode control module 15 enters the inductive ballast mode. The energy output from the inductive ballast LH passes through the rectification module 12 to generate a rectified signal Rs. In the inductive ballast mode, the rectified signal Rs is passes through the inductive ballast mode rectification unit 151 to generate a rectified output signal Rs′. The rectified output signal Rs′ passes through the isolation unit 152 to generate an isolation control signal Fs. The isolation control signal Fs passes through the switching control unit 153 to generate a switching control signal Ks for controlling the load LD.

The energy output from the main output terminals Ht2 and Ht3 of the inductive ballast LH is rectified through the rectification module 12, meaning that the rectification module 12 is reused when operating in the inductive ballast mode. The circuit structure is thereby simplified, significantly reducing the cost of the lighting device driver 1 and allowing its size to be reduced to achieve miniaturization.

In addition, the inductive ballast mode control module 15 includes the isolation unit 152, which has the photo coupler U1 and its corresponding circuit configuration. Furthermore, the inductive ballast mode control module 15 has a dedicated second ground GND2, which is different from the first ground GND1 of the rectification module 12, the driving control module 14, and the power conversion module 14. Therefore, the isolation unit 152 achieves effective isolation to separate the signal detection circuit from the power circuit, greatly reducing crosstalk signals.

As previously stated, the circuit structure of the lighting device driver 1 can not only perform the utility power mode and ballast mode but also the inductive ballast mode. Therefore, the circuit structure of the lighting device driver 1 can be significantly simplified, reducing its cost and enabling size reduction for miniaturization. Accordingly, the lighting device driver 1 meets actual requirements and future development trends.

The embodiment just exemplifies the disclosure and is not intended to limit the scope of the disclosure; any equivalent modification and variation according to the spirit of the disclosure is to be also included within the scope of the following claims and their equivalents.

To sum up, according to one embodiment of the disclosure, the lighting device driver includes an input module, a rectification module, a driving control module, a power conversion module and an inductive module. The input module couples an input signal. The rectification module is connected to the input module, and rectifies the input signal to generate a rectified signal. The driving control module is connected to the rectification module, and includes a control unit and a signal identification unit connected to each other. The power conversion module is connected to the driving control module, the control unit, and a load. The inductive ballast mode control module is connected to the input module, the rectification module, and the load. The inductive ballast mode control module includes an inductive ballast mode rectification unit, an isolation unit, and a switching control unit. The inductive ballast mode rectification unit is connected to the input module and the rectification module. The isolation unit is connected to the inductive ballast mode rectification unit. The switching control unit is connected to the isolation unit and the load. When the input module is connected to an inductive ballast, the inductive ballast mode control module enters the inductive ballast mode. In the inductive ballast mode, the rectified signal passes through the inductive ballast mode rectification unit to generate a rectified output signal. The rectified output signal passes through the isolation unit to generate an isolation control signal. The isolation control signal passes through the switching control unit to generate a switching control signal for controlling the load. Through the above circuit design, the lighting device driver can enter the inductive ballast mode when connected to an inductive ballast, such that the lighting device driver can be compatible with the inductive ballast and meet the requirements of different applications.

Also, according to embodiments of the present invention, in the inductive ballast mode, the energy output from the main output terminals of the inductive ballast is rectified through the rectification module, meaning that the rectification module is reused when operating in the inductive ballast mode. The circuit structure is thereby simplified, significantly reducing the cost of the lighting device driver and allowing its size to be reduced to achieve miniaturization.

Further, according to embodiments of the present invention, a portion of the input signal is coupled to the signal identification unit, causing the signal identification unit to generate an identification signal. The rectified signal drives the load through the driving control module and the power conversion module. The control unit controls the power conversion module to switch the operating mode thereof according to the frequency of the identification signal. The control unit enters the ballast mode when the frequency of the identification signal is greater than or equal to a preset frequency threshold. In the ballast mode, the control unit generates a direct-current signal to control the power conversion module to keep the switch of the power conversion module fully conductive. When the frequency of the identification signal is lower than the preset frequency threshold, the control unit enters the utility power mode. In the utility power mode, the control unit generates a pulse-width modulation signal to control the power conversion module for power conversion. Through the above control mechanism based on input signal identification, the lighting device driver can selectively output a direct-current signal or a pulse-width modulation signal to switch between the utility power mode and the ballast mode. In this way, the lighting device driver can be compatible not only with the inductive ballast but also with utility power and electronic ballast. Thus, the lighting device driver can achieve high compatibility and broader applicability.

Further, according to one embodiment of the disclosure, the lighting device driver achieves high compatibility through the above control mechanism based on input signal identification without requiring additional circuit modules. Furthermore, the circuit structure of the lighting device driver can simultaneously support the utility power mode, the ballast mode and the inductive ballast mode. As a result, the circuit structure of the lighting device driver can be significantly simplified, substantially reducing the cost of the lighting device driver. Therefore, the lighting device driver meets actual requirements. In addition, the size of the lighting device driver can be reduced to achieve miniaturization, aligning with future development trends.

Moreover, according to one embodiment of the disclosure, the driving control module of the lighting device driver further includes an impedance identification and detection unit. The impedance identification and detection unit is connected to the rectified signal output terminal of the rectification module and the control unit. It detects the impedance of the rectified signal, and the control unit enters a protection state when the impedance exceeds the preset impedance threshold. The above impedance detection mechanism effectively detects whether a human body resistance is connected to the lighting device driver, preventing electric shock. Thus, the safety performance of the lighting device driver is significantly improved.

Furthermore, according to one embodiment of the disclosure, the lighting device driver features a simple circuit design, allowing it to achieve the desired functionality while reducing costs. Moreover, the circuit design of the lighting device driver enables a smaller size, meeting the demands of high practicality for various applications.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is

1. A highly compatible lighting device driver, comprising:
an input module configured to couple an input signal;
a rectification module connected to the input module, and configured to rectify the input signal to generate a rectified signal;
a driving control module connected to the rectification module, and comprising a control unit and a signal identification unit connected to each other;
a power conversion module connected to the driving control module, the control unit, and a load; and
an inductive ballast mode control module connected to the input module, the rectification module, and the load.

2. The highly compatible lighting device driver as claimed in claim 1, wherein the inductive ballast mode control module comprises an inductive ballast mode rectification unit, an isolation unit, and a switching control unit, wherein the inductive ballast mode rectification unit is connected to the input module and the rectification module, the isolation unit is connected to the inductive ballast mode rectification unit, and the switching control unit is connected to the isolation unit and the load.

3. The highly compatible lighting device driver as claimed in claim 2, wherein when the input module is connected to an inductive ballast, the inductive ballast mode control module is configured to enter an inductive ballast mode, wherein in the inductive ballast mode, the rectified signal passes through the inductive ballast mode rectification unit to generate a rectified output signal, the rectified output signal passes through the isolation unit to generate an isolation control signal, and the isolation control signal passes through the switching control unit to generate a switching control signal so as to control the load.

4. The highly compatible lighting device driver as claimed in claim 1, wherein a portion of the input signal is coupled to the signal identification unit, causing the signal identification unit to generate an identification signal, wherein the rectified signal drives the load via the driving control module and the power conversion module, and the control unit is configured to control the power conversion module to switch an operating mode thereof according to a frequency of the identification signal.

5. The highly compatible lighting device driver as claimed in claim 4, wherein the control unit is configured to enter a ballast mode when the frequency of the identification signal is greater than or equal to a preset frequency threshold, wherein the control unit, in the ballast mode, is configured to generate a direct-current signal to control a switch of the power conversion module to remain fully conductive.

6. The highly compatible lighting device driver as claimed in claim 5, wherein the power conversion module comprises a switch unit, an output unit, and a sampling unit, wherein the switch unit is connected to the output unit and the sampling unit, and the sampling unit is connected to the control unit, wherein the rectified signal drives the load after being smoothed via the switching unit, the output unit, and the sampling unit.

7. The highly compatible lighting device driver as claimed in claim 4, wherein the control unit is configured to enter a utility power mode when the frequency of the identification signal is lower than a preset frequency threshold, wherein the control unit, in the utility power mode, is configured to generate a pulse-width modulation signal to control the power conversion module for power conversion.

8. The highly compatible lighting device driver as claimed in claim 7, wherein the power conversion module comprises a switch unit, an output unit, and a sampling unit, wherein the switch unit is connected to the output unit and the sampling unit, and the sampling unit is connected to the control unit, wherein the rectified signal drives the load via the switch unit, the output unit, and the sampling unit, wherein the sampling unit is configured to generate a feedback signal according to a peak current during a conduction of the switch unit, and the control unit is configured to adjust the pulse-width modulation signal according to the feedback signal.

9. The highly compatible lighting device driver as claimed in claim 4, wherein the driving control module further comprises an impedance identification and detection unit connected to a rectified signal output terminal of the rectification module and the control unit, wherein the impedance identification and detection unit is configured to detect an impedance of the rectified signal, and the control unit is configured to enter a protection state when the impedance exceeds a preset impedance threshold.

10. The highly compatible lighting device driver as claimed in claim 4, wherein the driving control module further comprises a direct-current signal smoothing unit connected to a rectified signal output terminal of the rectification module and the control unit, wherein the direct-current signal smoothing unit is configured to convert the rectified signal into a smoothed direct-current signal to supply power to the driving control module.
